(19) United States
(12) Patent Application Publication
(10) Pub. No.: US 2006/0179679 A1
(43) Pub. Date: Aug. 17, 2006

(54) Portable multi-purpose blower apparatus and method

(75) Inventor: Charles Wayne Ivey, Fayetteville, NC (US)

Correspondence Address: BAKER & HOSTETLER LLP, Washington Square, Suite 1100, 1050 Connecticut Avenue, N.W., WASHINGTON, DC, 20036, US

(73) Assignee: Marley Engineered Products,

(21) Appl. No.: 10/968,954

(22) Filed: Oct. 21, 2004

(51) Int. Cl. B08B 5/04; F26B 25/06

(52) U.S. Cl. 34/218; 134/21

(57) ABSTRACT

An embodiment of the portable blower includes a housing, a blower wheel, a motor, and a rechargeable battery. Some embodiments of the portable blower include a pivoting blower head, a speed control, and a light source. A method of assembling a portable blower includes attaching a blower wheel to a motor, fastening the motor and blower wheel assembly to a housing, and attaching a rechargeable battery to the housing.

### FIELD OF THE INVENTION

The present invention relates generally to air blowers. More particularly, the present invention relates to high velocity portable air blowers.

### BACKGROUND OF THE INVENTION

A direct, high velocity air stream is useful in a number of applications. A high-velocity air-stream can be used to cool an area where a person is working and does not otherwise have access to air conditioning or other air-cooling systems. For example, the work areas of mechanics, painters, plumbers, carpenters, or electricians are often in areas that are not typically occupied by people, and are therefore not air conditioned. A high-velocity air stream can be used to cool these areas for the comfort and productivity of the workers.

A high-velocity stream of air can also be used to ventilate a work area that does not have an adequate ventilation system. Similarly, a high velocity stream of air can be used as an exhaust, as the high velocity stream of air can send unwanted pollutants out of the workspace into a remote location. Additionally, a high velocity stream of air can be used to accelerate the drying of paint and other liquids.

To replace bulky solutions for air flow, including box fans and the like, so-called “portable,” high-velocity blowers have been created and placed on the market. These devices are able to deliver air at a high velocity without the requirement of a bulky, large fan. Instead of the larger fan, these blowers include powerful motors to drive a blower wheel at high speeds, driving the air flow at a velocity higher than would otherwise be possible with a fan of equivalent size.

However, although some of these blower devices claim to be portable, they lack a degree of portability often desired in remote workspaces. This is caused by the fact that some of these blower devices require attachment to a grounded 120 volt power outlet in order to drive the motor that drives the blower wheel. The use of electrical cords and wires can be inconvenient for a number of reasons. For example, a high velocity blower is sometimes needed in a wet environment, where there is a possibility that water or other liquids in the environment will come into contact with the electrical cord. Water or liquid contact with the electrical cord may increase the likelihood that the blower will malfunction.

Also 120-volt power outlets are often not available in remote workspaces where circulation, ventilation, or exhaust is desirable and otherwise not available, which is the prime location where a high velocity blower would be used. Thus, in order to power the blower, the blower's users would need to use a long extension cord connecting the blower to the closest 120-volt power outlet. Furthermore, the cord needs to be positioned so as to avoid any moisture that may be present in the work area, the existence of which is often the very reason a blower is used in the first place. Moisture in the work area, if it contacts an electrical cord, can result in malfunction of the blower.

Accordingly, it is desirable to provide a method and apparatus that provides high velocity air movement without the use of an electrical cord.

### SUMMARY OF THE INVENTION

The foregoing needs are met, to a great extent, by the present invention, wherein in one aspect an apparatus is provided that in some embodiments provides a method and apparatus that provides high velocity air movement without the use of an electrical cord.

In accordance with one embodiment of the present invention, a portable blower is provided. The portable blower includes a housing, an opening in the housing configured to vent a gas, a blower wheel assembly configured to blow air out of the opening, a motor configured to drive the blower wheel, and a rechargeable battery configured to provide power to the motor.

In accordance with another embodiment of the present invention, a method of assembling a portable blower is provided. The method includes attaching a blower wheel to a motor, fastening the motor and blower wheel assembly to a housing, and attaching a rechargeable battery to the housing.

In accordance with yet another embodiment of the present invention, a portable blower is provided. The portable blower includes a housing having an opening, a means for blowing a gas radially out of the opening, and a means for recharging a rechargeable battery that powers the portable blower.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front isometric view illustrating a portable blower according to an embodiment of the invention.

FIG. 2 is a side isometric view illustrating a portable blower according to an embodiment of the invention.

FIG. 3 is an isometric view taken illustrating a portable blower with ducting attached to the blower vent and inlet.

### DETAILED DESCRIPTION

The invention will now be described with reference to the drawing figures, in which like reference numerals refer to like parts throughout. An embodiment in accordance with the present invention provides a portable multi-purpose blower that uses a 12 volt direct current blower motor in conjunction with a self-contained rechargeable battery pack that makes it portable. Another embodiment in accordance with the present invention provides a method of moving air at a high velocity using a 12 volt direct current blower motor and a self-contained rechargeable battery pack.

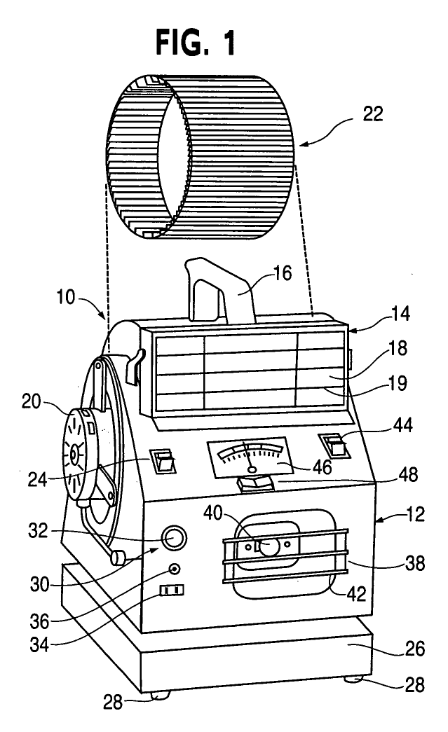

An embodiment of the present inventive apparatus and method is illustrated in FIG. 1, in which a portable multi-purpose blower 10 is shown. The blower 10 has a base housing assembly 12 in which the component parts are housed, protecting the components from the environment. The blower 10 includes a pivoting blower head 14, having a handle 16 and a vent 18. In some embodiments of the invention, the pivoting blower head 14 is at the top of the blower 10, the handle 16 is at the top of the pivoting blower head 14, the vent 18 is in the front of the blower head 14, and a grill 19 covers the vent 18.

Using this pivoting blower head 14 and the handle 16, the blower's 10 user can direct the flow of air in an up or down direction, and/or a left or right direction, without moving the entire blower 10. The user can better focus the air where blowing is needed, i.e. where workers are working or where a liquid needs to be quickly dried. The pivoting blower head 14 is useful if air needs to be focused in an upper direction above the blower 10. The blower head 14 can pivot upwards so that the air can be focused on the upper level of the room while the blower 10 is at a lower level in the workspace. The pivoting blower head 14 can pivot approximately 180 degrees and is secured at any point of the rotation by a large rubber O-ring that is positioned between the pivoting blower head 14 and the supporting base housing assembly 12.

The blower 10 also contains a motor 20. The motor 20 is located on the left side of the base housing unit 12 in the embodiment of the invention shown in FIG. 1, but it is understood that the motor 20 can be at other locations within the blower 10, including on the right side or in the back of the blower 10. The motor 20 is able to be powered with twelve volt, direct current power, instead of the 120-volt alternating current power that is used in multi-purpose blowers currently on the market. Because the motor 20 does not require 120-volt alternating current power, but can function with 12-volt direct current power, the motor 20 can be powered without being coupled to an alternating current electrical outlet and can accept alternate sources of power.

Inside the housing unit 12, adjacent to the motor 20 is a blower wheel 22. The blower wheel 22 is coupled to the motor 20, so that the motor 20 causes the blower wheel 22 to rotate. The rotation of the blower wheel 22 causes air to be moved radially, as opposed to axial air flow produced by a fan blades. The blower wheel 22 is configured so that the airflow can be directed out of the vent 18. As described above, the vent 18 is a part of the pivoting blower head 14, and the air coming out of the vent 18 can therefore be focused in a plurality of directions. In some embodiments of the invention, the blower wheel 22 can withstand being driven by the motor 20 at high velocities. The blower wheel 22 is adapted to rotate at high velocities, causing air to be driven through the vent 18 at high velocities. The blower wheel 22 generally works better than other fan designs against high static pressures.

As shown in FIG. 1, the blower 10 also includes a switch 24 which, in some embodiments of the invention, is located on the front face of the blower 10. The switch 24 is coupled to the motor 20. The switch 24 can be a binary switch, or can be a dial, or any other type of switch with more than two options. In some embodiments of the invention, the switch 24 is configured to control the velocity of the motor 20. In the case of the binary switch, the switch 24 can be used to turn the motor 20 on or off. In the case of the dial or other multi-option switch, the user of the blower 10 can adjust the switch so that the motor 20 rotates the blower wheel 22 at a variable velocity, for example, at a low, medium, or high velocity. In some embodiments of the invention the high speed operation of the motor is at 1622 revolutions per minute (RPM), and the low speed setting is at 640 RPM. The air flow rate at the high speed operation ranges from 300 to 400 cubic feet per minute. Multiple velocity options are useful because blowers 10 are used for a variety of functions and in a variety of workspaces of varying size.

In the embodiment of the invention as shown in FIG. 1, the blower 10 also includes a twelve volt rechargeable battery pack 26. In some embodiments, the battery pack 26 is beneath the housing unit 12, as a separate attachment to the blower 10, having a similar length and width as the housing unit 12. However, one of ordinary skill in the art may recognize that the battery pack 26 can be located at other places within or attached to the housing unit 12. The exterior of the battery pack 26 is made of a material that can withstand some physical and chemical irritants, and can be made from the same material used to construct the housing 12. The battery pack 26 has feet 28 which are used to support the battery pack 26 and the blower 10, so that it is not directly touching the floor or ground.

The battery pack 26 shown in FIG. 1 contains a twelve volt rechargeable battery. The battery life in some embodiments of the invention is approximately 2 to 3 hours at high speed operation, and approximately 8 hours at low speed operation. In some embodiments of the invention, the battery pack 26 can be recharged by connecting the battery 26 to a 120-volt alternating current power outlet. The battery pack 26 can contain an interface for a plug for use in a 120-volt alternating current power outlet, can contain a plug for use in a 120-volt alternating current power outlet, or an interface for a battery charger module (not shown) that accepts 120-volt alternating current power. Thus, in some embodiments, the battery pack 26 can be charged while not connected to the blower 10. This allows the blower 10 to be useable with a second battery pack 26 while the first battery pack 26 charges for future use.

As shown in FIG. 1, the blower 10 also contains a twelve volt direct current outlet 30. The outlet 30 can accept a twelve volt direct current plug, such as those used to plug electronic devices into automobile cigarette lighters. This is useful because users of the blower 10 may have other items that may need to be powered or charged, such as wireless telephones or power tools, which may have charging devices configured for use in an automobile or other twelve volt direct current outlet. The user can power or charge these devices while using the blower 10 without having any other independent power source. The outlet 30 is connected to the battery pack 26, and receives twelve volt direct current energy from the twelve volt direct current battery pack 26. In some embodiments, the outlet 30 has a cover 32 which protects the outlet 30 from contaminants which could be plentiful in the workspace.

In the embodiment of the blower 10 shown in FIG. 1, the blower 10 also contains a 120 volt alternating current charging receptacle 34 and a 12 volt direct current charging receptacle 36. The charging receptacle 34 is coupled, inside the housing unit 12, to a 120 volt alternating current to 12 volt direct current inverter. The 120 volt alternating current charging receptacle 34 allows the rechargeable battery pack 26 to be recharged from a 120 volt alternating current power source, while the 12 volt direct current charging receptacle 36 allows the rechargeable battery pack 26 to be recharged from a 12 volt direct current power source. The portable blower 10 is capable of operation from both the direct current power source and the alternating power source while it is being recharged.

Some embodiments of the invention, as shown in FIG. 1, have a light fixture 38 that includes a 12 volt high intensity lamp 40 and a grill 42. The lamp 40 provides illumination of the working area, and can be turned on and off by a light switch 44. The grill 42 shields the lamp 40 from contact with external object, but allows light to pass through. The lamp 40 receives power from the rechargeable battery pack 26. Although a grill 42 is shown in FIG. 1, other suitable covering devices, such as a translucent covering, are suitable as well.

A voltage meter 46 is shown if FIG. 1. The voltage meter 46 is activated by pushing a switch 48, and when activated it displays the remaining charge in the rechargeable battery pack 26. This allows the user of the portable blower 10 to determine when the blower must be recharged or when the battery pack 26 must be exchanged for a fresh battery pack 26.

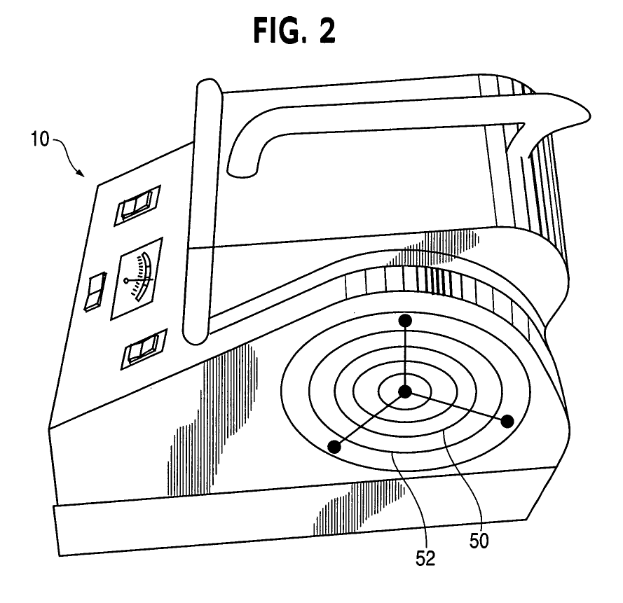

FIG. 2 shows an isometric view from a different angle of an embodiment of the portable blower 10. From this angle, the blower inlet 50 and the inlet grill 52 can be seen. Air is drawn into the portable blower 10 through the blower inlet 50 by the action of the rotating blower wheel 22 shown in FIG. 1. The inlet grill 52 reduces, the likelihood that large particulate matter will enter the portable blower 10. Although the blower inlet 50 is shown on the opposite side of the portable blower 10 as the motor 20 in FIGS. 1 and 2, in some embodiments of the invention the blower inlet 50 can be oriented differently on the portable blower 10 with respect to the motor 20.

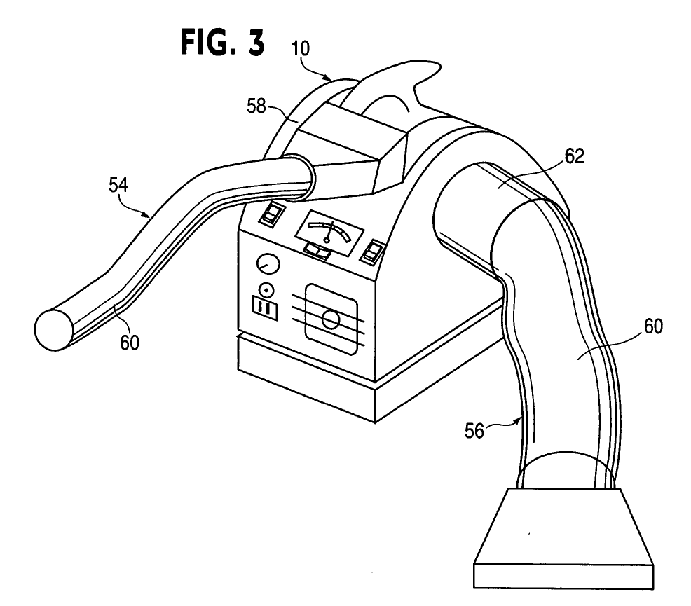

FIG. 3 shows an isometric view of a portable blower 10 with an exhaust duct 54 attached to the vent 18 and an inlet duct 56 attached to the blower inlet 50. The use of the ducts 54 and 56 is facilitated by the blower wheel 22 design which is capable of operating against high static pressures. The exhaust duct 54 is connected to the vent 18 by an exhaust adapter 58 and a length of flexible duct 60. Similarly, the inlet duct 56 is connected to the blower inlet 50 by an inlet adapter 62 and a length of flexible duct 60. The inlet duct 56 allows the portable blower 10 to remove fumes, smoke, and other gases or gas-like substances from one remote location, while the exhaust duct 54 allows the portable blower 10 to exhaust the fumes, smoke, and other gases or gas-like substances to another remote location.

The various parts of the portable blower 10 can be made of a variety of materials, such as metals, plastics, composite materials, ceramics, and any other suitable materials. Attachments and connections between the various parts of the portable blower 10 can be accomplished using screws, bolts, nails, rivets, adhesives, welds, or any other suitable means.

Although an example of the portable blower is shown using a twelve volt rechargeable battery and a twelve volt direct current motor, it will be appreciated that other voltages can be used. Also, although the portable blower is useful to ventilate an area it can also be used for, among other things, cooling, exhausting, and drying.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A portable blower, comprising:
a housing having a bottom side with a length and width;
an opening in the housing configured to vent a gas;
a blower wheel assembly disposed inside the housing and configured to blow air out of the opening;
a motor disposed within the housing and configured to drive the blower wheel; and
a rechargeable battery external to the housing and configured to provide power to the motor, the battery being detachably coupled to the bottom side of the housing and having a length and width substantially equal to the length and width of the bottom side of the housing, to form a base for the blower when attached to the housing.

2. The portable blower of claim 1, further comprising a pivoting blower head configured to direct the flow of air out of the opening in a plurality of directions.

3. The portable blower of claim 2, further comprising a handle connected to the pivoting blower head.

4. The portable blower of claim 2, wherein the blower head is capable of a one hundred eighty degree rotation.

5. The portable blower of claim 1, further comprising a speed control configured to adjust the rotational speed of the motor and blower wheel between a first speed and a second speed.

6. (canceled)

7. The portable blower of claim 1, further comprising a direct current outlet socket configured to provide direct current power from the rechargeable battery.

8. The portable blower of claim 1, further comprising a light configured to obtain power from the rechargeable battery.

9. The portable blower of claim 1, further comprising a voltage meter configured to determine a remaining level of power for the rechargeable battery.

10. The portable blower of claim 1, further comprising an exhaust duct configured to exhaust a gas from the location of the portable blower into a remote location.

11. The portable blower of claim 1, further comprising an intake duct configured to draw a gas from a remote location into the blower.

12. The portable blower of claim 1, further comprising a direct current inlet socket configured to recharge the rechargeable battery from a direct current power source.

13. The portable blower of claim 1, further comprising an alternating current inlet socket configured to recharge the rechargeable battery from an alternating current power source.

14-21. (canceled)

22. The portable blower of claim 1, further comprising to a plurality of feet on the bottom of the battery for contacting a surface on which the blower rests and elevating the battery above the surface.

23. The portable blower of claim 1, wherein the battery has disposed on the battery an interface for being charged while not connected to the blower.

24. The portable blower of claim 1, wherein the blower further comprises disposed on the housing both a first 120 Volt alternating current charging receptacle and a second 12 Volt direct current charging receptacle, to allow the rechargeable battery to be recharged from either the first or second charging receptacle.

25. A portable blower, comprising:
a housing having a bottom side with a length and width;
venting means in the housing configured to vent a gas;
blowing means disposed inside the housing and configured to blow air out of the venting means;
a motor disposed within the housing and configured to drive the blowing means; and
a rechargeable power supplying means external to the housing and configured to provide power to the motor, the power supplying means being detachably coupled to the bottom side of the housing and having a length and width substantially equal to the length and width of the bottom side of the housing, to form a base for the blower when attached to the housing.

26. The portable blower of claim 25, further comprising to a plurality of supporting means on the bottom of the power supplying means for contacting a surface on which the blower rests and elevating the battery above the surface.

27. The portable blower of claim 25, wherein the power supplying means has an interface disposed on the power supplying means for being charged while not connected to the blower.

28. The portable blower of claim 25, wherein the blower further comprises disposed on the housing both a first 120 Volt alternating current charging receptacle and a second 12 Volt direct current charging receptacle, to allow the rechargeable power supplying means to be recharged from either the first or second charging receptacle.

29. A method of powering a portable blower, comprising:
providing a housing having a bottom side with a length and width and disposed therein:
an opening in the housing configured to vent a gas;
a blower wheel assembly disposed inside the housing and configured to blow air out of the opening; and
a motor disposed within the housing and configured to drive the blower wheel; and
powering the blower via a rechargeable battery external to the housing and configured to provide power to the motor, the battery being detachably coupled to the bottom side of the housing and having a length and width substantially equal to the length and width of the bottom side of the housing, to form a base for the blower when attached to the housing.

30. The portable blower of claim 29, further comprising supporting the battery via a plurality of feet on the bottom of the battery for contacting a surface on which the blower rests to elevate the battery above the surface.

31. The portable blower of claim 29, wherein the battery pack contains an interface disposed on the battery for being charged while not connected to the blower.

32. The portable blower of claim 29, wherein the blower further comprises disposed on the housing both a first 120 Volt alternating current charging receptacle and a second 12 Volt direct current charging receptacle, to allow the rechargeable battery to be recharged from either the first or second charging receptacle.
